(19) United States
(12) Patent Application Publication
(10) Pub. No.: US 2009/0145561 A1
(43) Pub. Date: Jun. 11, 2009

(54) Air Bag Protection System

(76) Inventor: Philip I. Tennant, Hudson, FL (US)

Correspondence Address: ADVANTIA LAW GROUP, 9035 SOUTH 1300 EAST, SUITE 200, SANDY, UT, 84094, US

(21) Appl. No.: 11/951,470

(22) Filed: Dec. 6, 2007

(51) Int. Cl. E06B 9/02

(52) U.S. Cl. 160/377

(57) ABSTRACT

A novel removable building structure portal protector adapted to protect against damage to a building portals such as windows and doors during high wind conditions at least includes: a frame member adapted to be coupled to the periphery of a building portal; a plurality of anchor members adapted to anchor the frame member to a structure peripheral to the building portal; and a plurality of bladder members coupled to the frame members, and adapted to be coupled across and adjacent to the building portal, the bladder members being inflatable, and inflated in their protective state. The frame member and the bladder members cooperate to protect the building portal from wind and flying debris during high wind conditions.

### BACKGROUND OF THE INVENTION

1. Field of the Invention

The present invention relates to the protection and preservation dwellings, buildings and other structures during dangerous high-wind conditions.

2. Description of the Related Art

Hurricanes, tornadoes, monsoons, and other natural high-wind phenomena are responsible for great damage to building components such as windows and doors. The conventional response for protecting such components prior to the arrival of a storm and the like is to cover them with plywood or similar sheets of material by fastening the covering material to the structure surrounding the protected components. The aforementioned coverings are not only used to attempt to prevent wind damage to windows and doors, but to prevent damage from flying objects carried by high winds.

Plywood used as a covering material is both heavy, awkward to work with in the aforementioned application, and requires a great deal of space for storage. Additionally, the voluminous storage may be required for long periods of time between anticipated dangerous high-wind conditions.

What is therefore highly desirable but lacking in the prior art, is an approach to protecting windows and doors during dangerous high-wind conditions, which uses sturdy coverings that are easily put in place, lightweight, and collapsible for easy storage.

### SUMMARY OF THE INVENTION

The present invention has been developed in response to the present state of the art, and in particular, in response to the problems and needs in the art that have not yet been fully solved. Accordingly, the present invention has been developed to provide a novel removable building structure portal protector adapted to protect against damage to a building portal during high wind conditions. The protector at least includes: a frame member adapted to be coupled to the periphery of a building portal; a plurality of anchor members adapted to anchor the frame member to a structure peripheral to the building portal; and a plurality of bladder members coupled to the frame members, and adapted to be coupled across and adjacent to the building portal, the bladder members being inflatable, and inflated in their protective state. The frame member and the bladder members cooperate to protect the building portal from wind and flying debris during high wind conditions.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 contains a plan view and an end view of a first embodiment of the present-inventive building structure portal protector;

FIG. 2 contains a plan view and a side view of a second embodiment of the present-inventive building structure portal protector;

FIG. 3 contains plan views of third and fourth embodiments of the present-inventive building structure portal protector; and

FIG. 4 contains a plan view of a fifth embodiment of the present-inventive building structure portal protector, an end view of said protector with its bladder(s) in a non-inflated state, and an end view of said protector with its bladder(s) in an inflated state.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

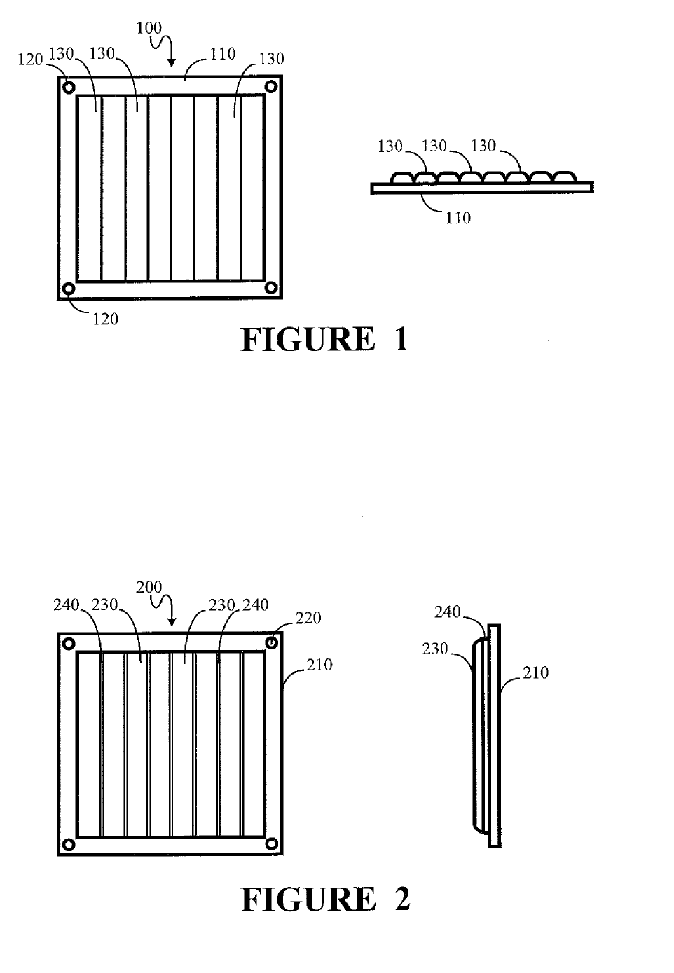

The present-inventive building portal protection system is specially adapted to protect building portals such as windows and doors from wind and debris during very high wind conditions. A first embodiment of a building portal protector 100 is illustrated in FIG. 1. The protector 100 contains a frame member which is attachable to the structure surrounding the portal by anchors 120. The anchors 120 can take many forms, including the combination of hardened steel bolts and permanently affixed (to the building structure) threaded couplers.

Several inflatable bladder members 130 are attached to the frames. In one particular embodiment, the frame member and the bladder member may be constructed from a unitary piece of material. In preparation for anticipated high wind conditions such as hurricanes and the like, the bladder members are inflated so that wind and objects headed for the protected building portal will not strike the portal, thereby preventing or lessening the likelihood of damage to the building portal. In the preferred embodiment, the bladder members, which may be constructed of any suitable material including strong fabric, rubber, and others, are independently inflated or deflated. This provides redundancy to prevent catastrophic failure of the protector if one of the bladder members is punctured or otherwise fails. While the inflated bladder members of the protector 100 resemble lenticules in their shapes, those skill in the art to which the present invention pertains will understand that many other shapes are possible, given the teachings of this Letters Patent.

Another embodiment of a building portal protector is illustrated in FIG. 2. The protector 200 in FIG. 2 is substantially the same as the protector in FIG. 1, except that it contains several lightweight spar members or spars 240 to increase the structural strength of the protector. The bladder members 230 are coupled around the spars as shown.

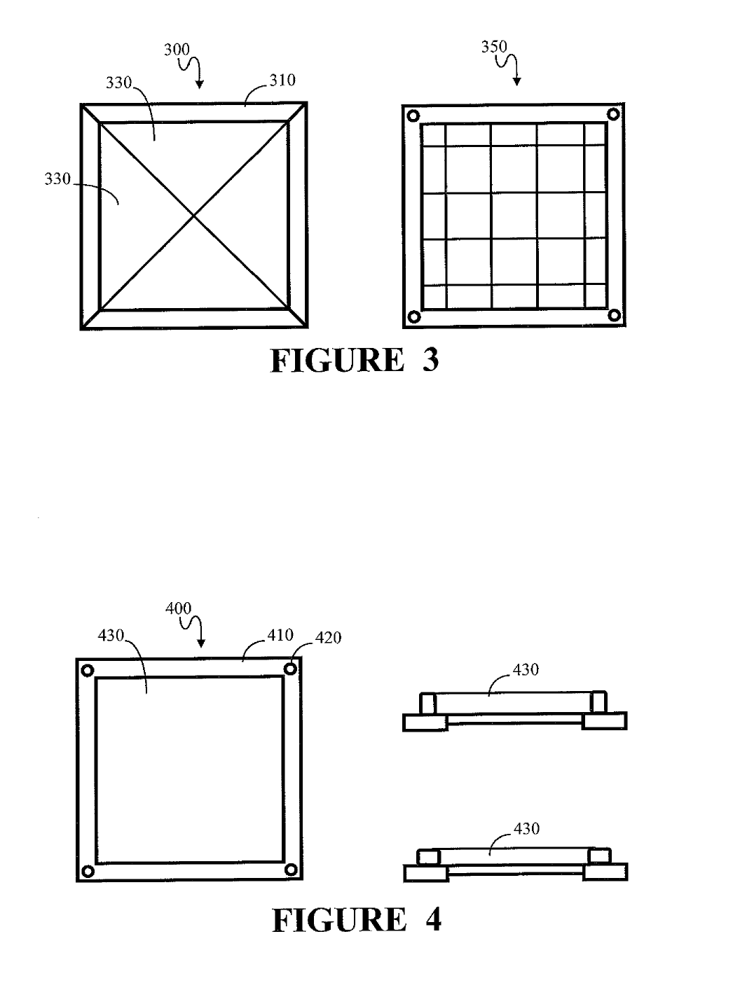

The frame member and bladder members can have a variety of configurations such as the examples (300 and 350) shown in FIG. 3. In one embodiment, the frame member is collapsible. In another embodiment, the frame member is flexible. The flexibility of the frame member according to this embodiment may allow the frame member to be packed by, for example, rolling up, stuffing, folding, and so forth. Further, as shown in the example of FIG. 4, the bladder members 430 can be connected to the frame member with couplers that pivot to allow expansion when the bladder members are in the inflated state.

In one embodiment, the present invention may be placed upon a relatively planar member of a structure. The relatively planar member may be, for example, a wall, ceiling, floor, door, window, and so forth. Thus, when the various forces are placed upon the planar member, the structure is not substantially damaged or invaded by these forces. In one embodiment, the present invention may be placed upon the structure such that the structure is protected from water invasions from, for example, storm surges, hurricanes, floods, and the like. In another embodiment, the present invention may be placed upon a structure so as to protect the structure from flying objects. These embodiments may be used in conjunction with each other. Further, these embodiments may be of particular advantage in windy and wet weather conditions such as a hurricane, tornado, tsunami, and the like, and even in conditions which may promote flooding, broken levies, tidal surge, and the like.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A removable building structure portal protector adapted to protect against damage to a building portal during high wind conditions, said protector comprising:
a frame member adapted to be coupled to the periphery of a building portal;
a plurality of anchor members adapted to anchor said frame member to a structure peripheral to said building portal; and
a plurality of bladder members coupled to said frame members, and adapted to be coupled across and adjacent to said building portal, said bladder members being inflatable, and inflated in a protective state;
wherein said frame member and said bladder members cooperate to protect said building portal from wind and flying debris during high wind conditions.

2. The protector in claim 1, wherein said building portal comprises at least one window.

3. The protector in claim 1, wherein said building portal comprises at least one door.

4. The protector in claim 1, wherein said bladder members are lenticularly positioned.

5. The protector in claim 1, wherein said frame member is collapsible.

6. The protector in claim 1, wherein said bladder members are independently inflatable and deflatable.

7. The protector in claim 1, further comprising:
a plurality of support spars, each said support spar coupled to said frame member and to at least one bladder member.

8. A removable building structure portal protector adapted to protect against damage to a building portal during high wind conditions, said protector consisting of:
a frame member adapted to be coupled to the periphery of a building portal;
a plurality of anchor members adapted to anchor said frame member to a structure peripheral to said building portal; and
a plurality of bladder members coupled to said frame members, and adapted to be coupled across and adjacent to said building portal, said bladder members being inflatable, and inflated in a protective state;
wherein said frame member and said bladder members cooperate to protect said building portal from wind and flying debris during high wind conditions.

9. The protector in claim 8, wherein said building portal consists of at least one window.

10. The protector in claim 8, wherein said building portal consists of at least one door.

11. The protector in claim 8, wherein said bladder members are lenticularly positioned.

12. The protector in claim 8, wherein said frame member is collapsible.

13. The protector in claim 8, wherein said bladder members are independently inflatable and deflatable.

14. The protector in claim 8, further consisting of:
a plurality of support spars, each said support spar coupled to said frame member and to at least one bladder member.

15. A removable building structure portal protector adapted to protect against damage to a building portal during high wind conditions, said protector consisting essentially of:
a frame member adapted to be coupled to the periphery of a building portal;
a plurality of anchor members adapted to anchor said frame member to a structure peripheral to said building portal; and
a plurality of bladder members coupled to said frame members, and adapted to be coupled across and adjacent to said building portal, said bladder members being inflatable, and inflated in their protective state;
wherein said frame member and said bladder members cooperate to protect said building portal from wind and flying debris during high wind conditions.

16. The protector in claim 15, wherein said building portal consists essentially of at least one window.

17. The protector in claim 15, wherein said building portal consists essentially of at least one door.

18. The protector in claim 15, wherein said bladder members are lenticularly positioned.

19. The protector in claim 15, wherein said frame member is collapsible.

20. The protector in claim 15, wherein said bladder members are independently inflatable and deflatable.
